(19) United States
(12) Patent Application Publication
(10) Pub. No.: US 2012/0244394 A1
(43) Pub. Date: Sep. 27, 2012

(54) ENERGY STORAGE UNIT HAVING EXTENDED SERVICE LIFE

(75) Inventors: Claus-Rupert Hohenthanner, Hanau (DE); Tim Schaefer, Niedersachswerfen (DE); Andreas Gutsch, Luedinghausen (DE); Markus Wohnig, Dresden (DE)

(73) Assignee: Li-Tec Battery GmbH, Kamenz (DE)

(21) Appl. No.: 13/499,995

(22) PCT Filed: Sep. 22, 2010
(86) PCT No.: PCT/EP2010/005803

§ 371 Date: Jun. 8, 2012

(30) Foreign Application Priority Data
Oct. 5, 2009 (DE) 10 2009 048 249.0

(51) Int. Cl. H01M 10/50; H01M 2/10

(52) U.S. Cl. 429/50; 429/72; 429/71; 429/62; 29/426.2

(57) ABSTRACT

A device for storing electrical energy, according to the invention has at least
one galvanic cell (1). Further, the device of the invention comprises at
least one cell holding means having at least one interior space provided to at least partially accommodate the at least one galvanic cell. Further, the device of the invention comprises at least
one first wall element, which at least partially surrounds the interior space (47) of the cell holding means (4) and is at least partially operatively connected to the at least one galvanic cell. Further, the device comprises at least
one heat conducting means, which is operatively connected to the at least one first wall element. Further, the device of the invention comprising at least
one fluid channel, which is assigned to the heat conducting means and is provided to be flown through by a first fluid. The device of the invention is
characterized in that it
comprises at least one position adjusting means configured to expand, wherein at least the position adjusting device is arranged at least partially within the cell holding means.

Priority application DE 10 2009 048 249.0 as filed on Oct. 5, 2010 is fully incorporated herein by reference.

The present invention relates in general to energy storage units. The invention is described in connection with rechargeable lithium-ion batteries for supplying motor vehicle drives. It is pointed out that the invention can also be applied irrespective of the type of construction of the galvanic ceil, its chemistry and also irrespective of the type of drive supplied.

Rechargeable batteries having a plurality of galvanic cells for supplying motor vehicle drives are known from the prior art. During the operation of such a battery, irreversible chemical reactions also occur in the galvanic cells. These reactions also lead to an increasing reduction in the charging of the galvanic cells.

The object of the invention is to maintain the charging capacity of the galvanic cells of a battery over a larger number of charging cycles.

This object is achieved according to the invention by the subject matter of the independent claims. Preferred embodiments of the invention form the subject matter of the dependent claims.

A device according to the invention for storing electrical energy has at least one galvanic cell. The device according to the invention further comprises at least one cell holding means/holder having at least one interior space provided to at least partially accommodate the at least one galvanic cell. The device according to the invention further comprises at least one first wall element, which at least partially surrounds the interior space of the cell holder and is at least partially operatively connected to the at least one galvanic cell. The device according to the invention further comprises at least one heat conducting means which is operatively connected to the at least one first wall element. The device according to the invention further comprises at least one fluid channel which is assigned to the heat conducting means and through which a first fluid flows. The device according to the invention is characterized in that it comprises at least one position adjusting means which is configured to expand, wherein at least the position adjusting means is arranged at least partially within the cell holder.

In the context of the invention a galvanic cell is to be understood as a device which also serves the purpose of storing chemical energy and emitting electrical energy. The galvanic cell can also be configured to convert electrical energy into chemical energy when charging and to store it. This is then known as a secondary cell or an accumulator. In the context of the invention a heat conducting means is to be understood a device which also has an increased thermal conductivity compared to the galvanic cells. In particular, it supplies thermal energy to an operatively connected galvanic cell. This is desirable in particular at low ambient temperatures, in order to counteract premature ageing of the galvanic cell and to increase its efficiency. The heat conducting means also dissipates thermal energy out of an operatively connected galvanic cell, whereby this is in particular protected and its service life is extended. In particular during a charging and/or discharge cycle with high charging and/or discharge current, the galvanic cell heats up, wherein too high a temperature of a galvanic cell shortens its service life and/or destroys the galvanic cell.

In the context of the invention a fluid is to be understood as a substance which essentially presents no resistance to an arbitrarily small shear stress. Gases and liquids are fluids in this sense.

In the context of the invention a fluid channel is to be understood as a device which also holds and conveys at least one first fluid or can at least retain this first fluid, if this fluid channel is configured as a closed space. This fluid channel is preferably provided to also hold and convey or retain a second fluid. The fluid channel preferably has at least one inlet region and at least one outlet region for at least the first fluid, wherein at least the first fluid preferably flows through the channel from at least this inlet region to at least this outlet region. At least the first fluid preferably has a lower or higher temperature than the interior space of the fluid channel and/or the fluid channel wall and/or at least one device operatively connected to the fluid channel. At least the first fluid is heated or cooled depending on the prevailing temperatures, whereby thermal energy is dissipated out of the interior chamber of the fluid channel and/or the fluid channel wall and/or at least one device operatively connected to the fluid channel, or is supplied thereto.

In the context of the invention, a cell holding means/holder is to be understood as a device having an interior space and at least one first wall element which at least partially surrounds this interior space. The wall element is not provided to completely enclose this interior space. The interior space is configured so as to at least partially hold the at least one galvanic cell. The interior space is preferably configured to hold further devices in addition to the at least one galvanic cell, such as in particular measurement devices, control devices and at least one position adjusting device. The at least one galvanic cell which is held and at least the additional held devices are preferably enclosed by this cell holder by means of a force fit and/or in a thermally conducting manner. The at least one galvanic cell is preferably enclosed by the cell holder such that at least one first outer surface of the associated cell casing at least partially forms a surface solid-solid contact with at least the first wall element. An advantage of this arrangement is that thermal energy to be dissipated from the galvanic cell is conducted without further solid-solid contacts directly to the outside of the cell holder. At least the first wall element of the cell holder preferably consists of a highly thermally conductive metallic material, and particularly preferably of aluminum.

In the context of the invention a position adjusting means is to be understood as a device which is configured to expand, preferably in a temperature-dependent manner and/or depending on the ambient pressure acting thereon, in a preferred direction, wherein a force is also exerted at least on the galvanic cell in the direction of the first wall element. The position adjusting means is to be in particular operatively connected inside at least one cell holder to at least one galvanic cell with a force fit.

The nature and/or size of a force exerted by at least this position adjusting means preferably depends essentially on the temperature thereof and the ambient pressure acting thereon. Advantageously, the nature and/or size of the force exerted by at least this position adjusting means can be predefined by its geometric form and/or the material from which it is manufactured. The temperature-dependently exerted force of the position adjusting means for a constant ambient pressure is preferably described, at least in some intervals, by at least one mathematical function.

In particular under conditions of high thermal stress on the galvanic cell, a discontinuity or disruption of the thermal energy flow leads to a heat build-up inside the galvanic cell and/or the cell holder, which would cause the operating temperature of this galvanic cell to rise. In particular, high operating temperatures of this galvanic cell lead to a reduced service life and thereby also to a lower number of possible charging and/or discharge cycles. Under very high thermal stress in lithium-ion accumulators it can lead to melting of the separator, which destroys the lithium-ion accumulator. Furthermore, the capacity of a lithium-ion accumulator reduces over time, in particular due to parasitic reactions of the lithium with the electrolyte. This breakdown speed increases with rising temperature.

An increase in volume of the at least one galvanic cell during the charging cycle is preferably compensated by a corresponding reduction in volume at least of the associated position adjusting means, and a deformation and/or destruction of the at least one galvanic cell and/or at least the cell holder is prevented. Preferably, the position adjusting means regulates the contact pressure of the at least one galvanic cell on at least the first wall element, preferably at a constant value.

Volume changes in the associated galvanic cell, which are unavoidable during charging and/or recharging cycles, are at least partially compensated by this position adjusting means. The thermal contact between the at least one galvanic cell and the first wall element is improved and/or guaranteed by the position adjusting means. A reduction in volume of the at least one galvanic cell during the discharge cycle is preferably compensated by a corresponding increase in volume at least of the associated position adjusting means, and the thermally conducting solid contact between the at least one galvanic cell and at least the first wall element is maintained also in this case. In particular, too small a contact pressure of the galvanic cell on at least the first wall element leads to a discontinuity or disruption in the thermal energy flow between the at least one galvanic cell and at least the first wall element. Preferably, the position adjusting means regulates the contact pressure of the at least one galvanic cell on at least the first wall element, and preferably at a constant value Thus the object of the invention is achieved.

In the following, preferred embodiments of the invention will be described.

According to the invention a separator is preferably used, which consists of a material-permeable substrate, preferably partially material-permeable, i.e. substantially permeable in relation to at least one material and substantially impervious in relation to at least one other material. The substrate is coated on at least one side with an inorganic material. As the material-permeable substrate an organic material is preferably used, which is preferably implemented as a non-woven fabric. The organic material, preferably a polymer and particularly preferably polyethylene terephthalate (PET), is coated with an inorganic ion-conducting material which is preferably ion-conducting in a temperature range of −40° C. to 200° C. The inorganic ion-conducting material preferably comprises at least one compound from the group oxides, phosphates, sulphates, titanates, silicates, aluminosilicates having at least one of the elements Zr, Al, Li, especially zirconium oxide. Preferably, the inorganic, ion-conducting material has particles with a maximum diameter of less than 100 nm. Such a separator is sold in Germany under the trade name “Separion” by Evonik AG, for example.

In the context of the invention a longitudinal axis is understood to mean an axis of a body which extends along its greatest extension and which substantially corresponds to an axis of symmetry. Advantageously the longitudinal axes of a galvanic cell and a cell holder and a position adjusting means and a heat conducting means extend substantially parallel. This arrangement of the essentially plate-like components enables a high packing density of the device according to the invention. In this arrangement, adjacent components touch each other over a surface area, wherein with increasing number of touching points the thermal conductivity of the solid body contact formed is improved.

Particularly advantageously, a plurality of cell holders and heat conducting means are arranged inside the device according to the invention, wherein at least one cell holder encloses at least one galvanic cell and at least one position adjusting means. A preferred arrangement is one inside which cell holders and heat conducting means are arranged substantially alternately. Advantageously at least one heat conducting means is associated with each cell holder, and is operatively connected to at least this associated cell holder. Preferably, in order to increase the electrical voltage and/or the amount of charge contained, a device according to the invention consisting of a plurality of cell holders and heat conducting means has a plurality of galvanic cells connected in parallel and/or series. Also, to obtain a specified operating voltage, for example sets of four galvanic cells are preferably connected in series as a group. Multiple such groups are preferably connected in parallel and store a larger amount of charge.

The device according to the invention preferably has at least one first shaped part, wherein the first shaped part is provided to be operatively connected and/or glued to at least the first wall element of the cell holder. Preferably at least the first shaped part is arranged substantially perpendicular at least to the cell holder. The first shaped part is preferably configured such that it is operatively connected to a plurality of wall elements of a plurality of cell holders. At least the first shaped part is preferably configured such that it at least partially encloses at least one associated heat conducting means. At least the first shaped part is preferably produced from a plastic or synthetic resin, wherein this first shaped part is preferably non-conducting.

Particularly advantageously, the device according to the invention has at least one second shaped part, wherein at least this second shaped part is arranged substantially opposite the first shaped part and wherein the second shaped part is provided for being operatively connected and/or glued to at least the first wall element of the cell holder. A preferred configuration of this second shaped part has at least one opening, wherein this opening is provided for the passage of at least one current collector of at least one galvanic cell. Preferably, at least the second shaped part is arranged substantially perpendicular at least to the cell holder. The second shaped part is preferably configured such that it is substantially operatively connected to a plurality of wall elements of a plurality of cell holders. At least the first shaped part is preferably configured such that it at least partially encloses at least one associated heat conducting device. At least the second shaped part is preferably made from a plastic or synthetic resin, wherein this second shaped part is preferably non-conducting.

The device according to the invention preferably has at least one cavity, said cavity being provided for accommodating at least one heat conducting means. This cavity is preferably at least partially bounded on each of two opposing sides by at least one first wall element of the associated cell storage devices. Furthermore, this cavity is preferably at least partially bounded on each of two other opposing sides by at least the first and the second shaped part respectively. This cavity is preferably open on two further sides, wherein a first fluid channel is produced between at least two adjacent first wall elements of the associated cell holders, which passes through the device according to the invention from a first side to a second side lying opposite to this first side.

This cavity is preferably also suitable for heat conduction and represents a preferred configuration of a heat conducting means. At least one first fluid flows through this heat conducting means. Preferably, this first fluid either absorbs thermal energy or emits it while flowing through the heat conducting means, depending on its temperature and the prevailing temperatures inside this heat conducting means or this first fluid channel.

In the context of the invention a pumping means/device is to be understood as a device which is also provided to pump at least one fluid. Preferably at least one fluid is introduced from preferably at least one container assigned to the pumping device, preferably using at least one fluid pump assigned to the pumping device via preferably at least one pipeline assigned to the pumping device using preferably at least one valve assigned to the pumping device, preferably into at least one fluid channel and/or discharged at least from this fluid channel. At least one heat exchanger is preferably assigned to the pumping device, which is provided at least for controlling the temperature of the fluid pumped by the pumping device. The pumping device is preferably signal connected at least to the control device, wherein the control device is provided at least to adjust at least two operating states of the pumping device.

At least one first pumping device is preferably adjacent to the device according to the invention, which is provided at least to pump this first fluid inside at least the first fluid channel. The pumping device can also extract the fluid from a storage container or from a supply system or can feed the fluid via a valve controlled by a control device from the supply system directly to at least the first fluid channel.

Preferably, in particular when there is a high cooling requirement, at least a second pumping means/device is associated at least to this heat conducting means. This second pumping device is provided for pumping at least a second, preferably incompressible fluid, inside at least the first fluid channel. The pumping device can also extract the fluid from a storage container or from a supply system or can feed the fluid via a valve controlled by a control device from the supply system directly to at least the first fluid channel. Depending on the prevailing temperatures inside the first heat conducting device and the chemical composition of this second fluid, it undergoes phase changes, preferably from a liquid to a gaseous form or vice versa. Preferably one of the phase transition temperatures of this fluid lies below the maximum intended operating temperature of the device according to the invention.

At least this first fluid channel preferably comprises, at least in some regions, a capillary-active non-woven fabric, which is provided for wetting at least the first wall element at least partly with at least the second fluid.

Preferably, the heat conducting means comprises is associated with a distribution device, which is provided for introducing at least a second fluid into at least the first fluid channel and for distributing this fluid over at least the capillary-active non-woven fabric, at least in some regions.

This distribution device has at least one device associated with it for generating turbulence of at least the first fluid, wherein a turbulence at least of this first fluid promotes phase changes of the second fluid, in particular from a liquid to a gaseous form.

The device according to the invention preferably has a third pumping means/device associated with it, which is provided for pumping at least a first multi-phase fluid inside at least the first fluid channel. The evaporation of the liquid fluid constituents of this multi-phase fluid in the first fluid channel in particular reduces the prevailing temperatures inside the fluid channel. The pumping device can also extract the fluid from a storage container or from a supply system or can feed the fluid via a valve controlled by a control device from the supply system directly to at least the first fluid channel.

In one configuration of the device according to the invention, at least the first heat conducting means is preferably at least partially filled with a preferably thermally conducting metal. At least this metallic core of the heat conducting device preferably comprises at least one second fluid channel, through which at least one third, preferably incompressible, fluid flows. Further preferably, a plurality of second fluid channels is assigned to this metallic core, or constructed inside the metallic core. At least one second fluid channel preferably has a round or rectangular cross-section. The channel preferably extends in a meandering manner or preferably in a straight line through the metallic core, advantageously in the direction of a longitudinal axis of the metallic core. At least two second fluid channels are preferably connected to a continuous fluid channel with at least one connecting element. A fourth pumping device is preferably associated to the device according to the invention, which is provided for pumping at least the third fluid inside at least the third fluid channel.

A plurality of cell holders and heat conducting means with metallic cores is preferably integrally constructed from the same material. This integrally constructed module is preferably an extruded profile element and preferably an aluminum extruded profile element. In particular, this integral configuration has the advantage that solid-solid contacts are avoided, in particular between at least the first wall element of the cell holder and the associated heat conducting means with metallic core, wherein the thermal energy flow inside the device according to the invention is improved.

The at least one first wall element preferably comprises at least in some regions at least one preferably metallic fin, which is also provided to enlarge the surface in particular of the outside of the first wall element of the cell holder. The enlarged surface improves the heat transfer, in particular the absorption or emission of heat radiation on the outside of the at least one first wall element.

In the context of the invention, a current collector is understood to mean a lattice material, which is also provided to facilitate the controlled removal of the stored chemical energy in the form of electrical energy. The current collector also introduces electric current into the galvanic cell, wherein this electrical energy is converted into chemical energy and stored inside the galvanic cell. This current collector is preferably metallic and has a high thermal conductivity. The current collector comprises a first region which is arranged inside the galvanic cell, and a second region, wherein this second region is arranged outside the galvanic cell.

This second region is preferably cooled or heated by heat transfer, in particular heat conduction to a heat sink or by convection. Particularly preferably, this heat sink or this second region of the current collector at least partially has at least a fourth fluid flowing around it. Depending on the temperature difference between this fourth fluid and the current collector and/or the heat sink, thermal energy is supplied to the galvanic cell or removed from it. The heat sink is also preferably composed of a material from a group of metals which also contains copper, nickel, chromium, aluminum and silver.

The device according to the invention preferably comprises a third fluid channel, which is provided to convey at least the fourth fluid at least in some regions via at least one current collector, or via at least one heat sink effectively connected to this current collector. Preferably, the device according to the invention has a fifth pumping device associated with it, which is provided for pumping at least this fourth fluid inside at least the fifth fluid channel.

At least the first wall element preferably has a higher absorption coefficient for heat radiation, at least in some regions, than at least the galvanic cell. In particular, electromagnetic radiation emitted by the galvanic cell is preferably absorbed by the wall element with a higher absorption coefficient, whereby heat build-up inside the galvanic cell and/or inside the cell holder is substantially prevented.

The energy storage unit with extended service life preferably comprises at least one first measuring means/measurement device, which is provided for detecting a measurement variable, in particular the temperature at a specified position of the galvanic cell. The energy storage unit further comprises a controlling means/control device, which is provided for detecting a signal of at least a first measurement device and/or controlling the at least one heat conducting device.

In the context of the invention a first measuring means/measurement device is understood to mean a device which is provided for detecting a measurement variable, in particular the temperature at a specified position of a galvanic cell. Multiple measuring means for detecting temperatures and/or pressures at different positions of a galvanic cell are also preferably connected to a measurement device. This measurement device is suitable for recording the signals from the measurement means at all times. From practical considerations and in order to reduce the amount of data, the detection preferably only takes place from time to time. This is also dependent on the thermal capacities and heat transfer coefficients. A first measurement device provides at least one signal to a control device which is also present. This control device preferably initiates the detection of temperatures by a first measurement device in accordance with the operating conditions.

In the context of the invention a controlling means/control device is understood to mean a device which is provided for at least controlling the at least one first measurement device and for analysing its signals. This occurs on the basis of specified calculation rules. These take account of differing characteristics of the individual measurement means. The control device is also suitable for controlling available heat conducting devices. This involves switching individual or a plurality of heat conducting devices, depending on the operating state of a galvanic cell. The functions of this control device of the device according to the invention can also be carried out by another controller or a battery management system.

Advantageously, the device according to the invention is also equipped with at least one second measurement device. This device is suitable for detecting the charging or discharging current into or out of an assigned galvanic cell and transmitting it to this control device. The number of both measurement devices thus corresponds to the number of galvanic cells, but is preferably also lower. The detection of the current level takes place continuously, but preferably after setting this control device according to the operating conditions.

Advantageously, a device according to the invention is operated such that its control device first of all detects the temperature at a specified location of a galvanic cell. In accordance with this temperature, this control device switches a heat conducting means on or off. The control device preferably switches at least one pumping device for fluids on or off. A premature ageing of a device for storing electrical energy is thus mitigated and its service life extended.

Advantageously, this control device is connected to a memory device. This is used for storing acquired data, analysed measurement variables and/or calculation rules. Together with a measurement variable or an analysed measurement variable an additional value is stored which is representative of the time of the measurement. Specifications or target values for a measured parameter, such as the temperature of a cell, are stored in this memory device.

Particularly advantageously, the device comprises a control device, an associated memory device and at least one first measurement device. This control device is suitable for generating a difference of a measurement variable or signal from this first measurement device and a specified value. In accordance with this temperature difference this control device switches a heat conducting device on or off. Preferably, the control device switches pumping devices for fluids on or off. A premature ageing of a device for storing electrical energy is thus mitigated and its service life extended.

Particularly advantageously, the device comprises a control device, an associated memory device, at least one first measurement device and at least one second measurement device. This control device is suitable for generating a difference of a measurement variable or signal from this first measurement device and a specified value. This control device is further suitable for linking the measurement variables of a first measurement device with a signal from a second measurement device by using a stored calculation rule. Using appropriate linking of measured current levels and determined temperatures or temperature differences, the control device preferably estimates the future temporal development of the cell temperature using stored calculation rules. In expectation of a future temperature change of a galvanic cell, the control device preferably switches heat conducting devices and/or pumping devices for a fluid on or off. For example, in the event of a high discharge current during an acceleration phase of the motor vehicle, the control device switches on a pumping device for a fluid and/or a heat conducting device prior to a noticeable rise in the temperature of a cell.

The energy storage device according to the invention is preferably configured such that a plurality of these energy storage devices can be preferably mechanically and/or magnetically connected, wherein in particular at least two fluid channels of at least two energy storage devices can also be connected to a continuous channel.

Further advantages, features and configurations of the present invention are obtained from the following description in connection with the figures, which show:

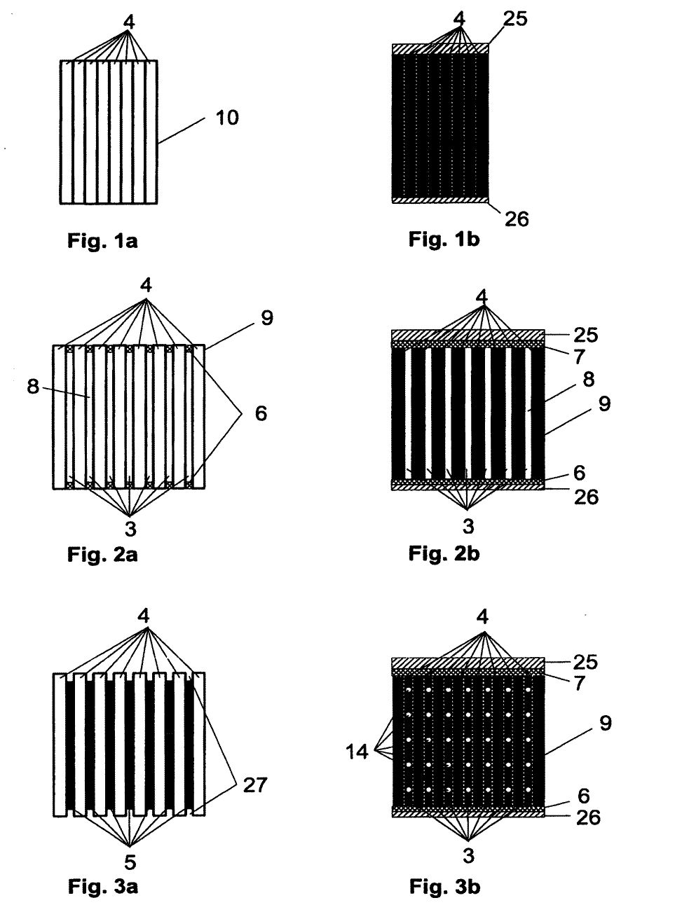

FIG. 1a a cross-section of an aluminum extruded profile element for the device according to the invention;

FIG. 1b a side view of an aluminum extruded profile element for the device according to the invention;

FIG. 2a a cross-section of an aluminum extruded profile element for the device according to the invention;

FIG. 2b a side view of an aluminum extruded profile element for the device according to the invention;

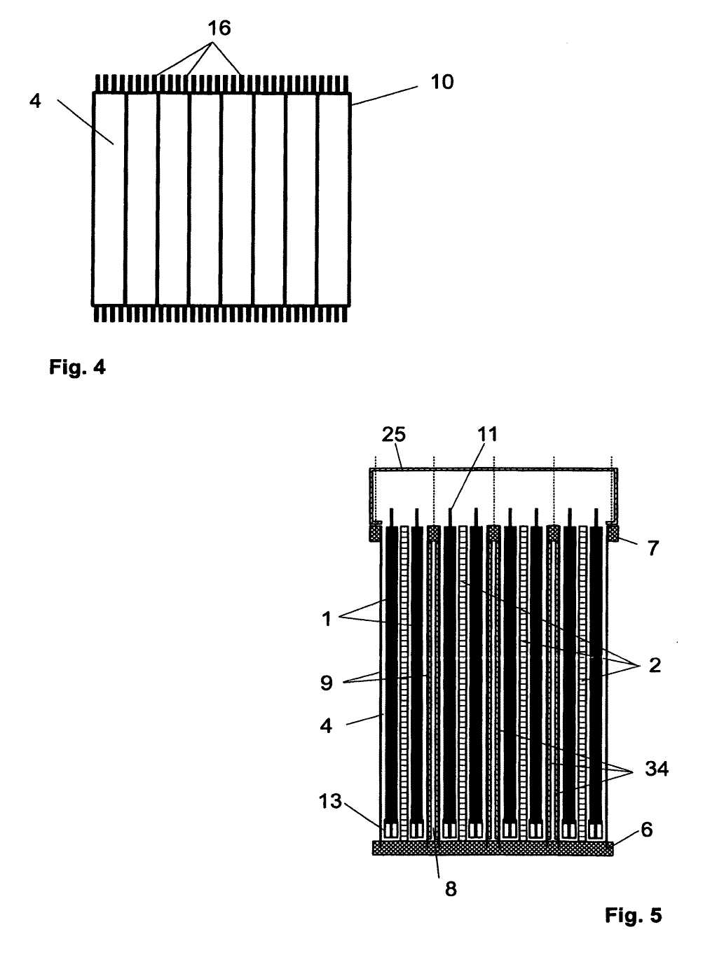

FIG. 3a a cross-section of an aluminum extruded profile element for the device according to the invention;

FIG. 3b a side view of a preferred embodiment of the device according to the invention;

FIG. 4 a cross-section of an aluminum extruded profile element with cooling fins on the outside;

FIG. 5 a longitudinal section through a device according to the invention having air cooling;

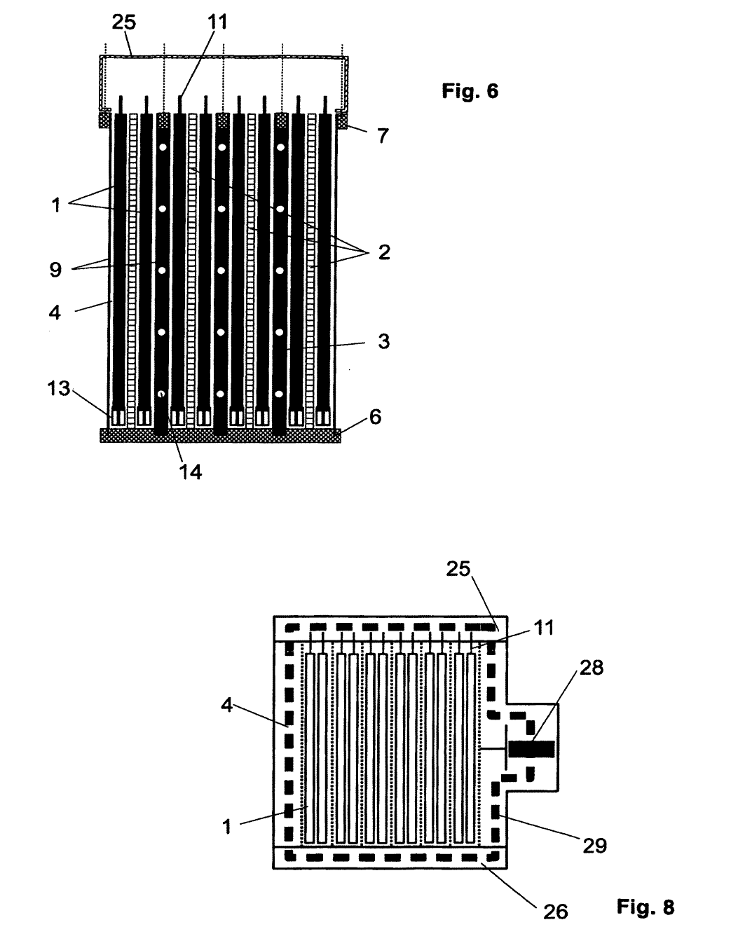

FIG. 6 a longitudinal section through a device according to the invention having liquid cooling;

FIG. 7a a connecting element for fluid channels through which a gaseous fluid is flowing;

FIG. 7b a connecting element for fluid channels through which a liquid fluid is flowing;

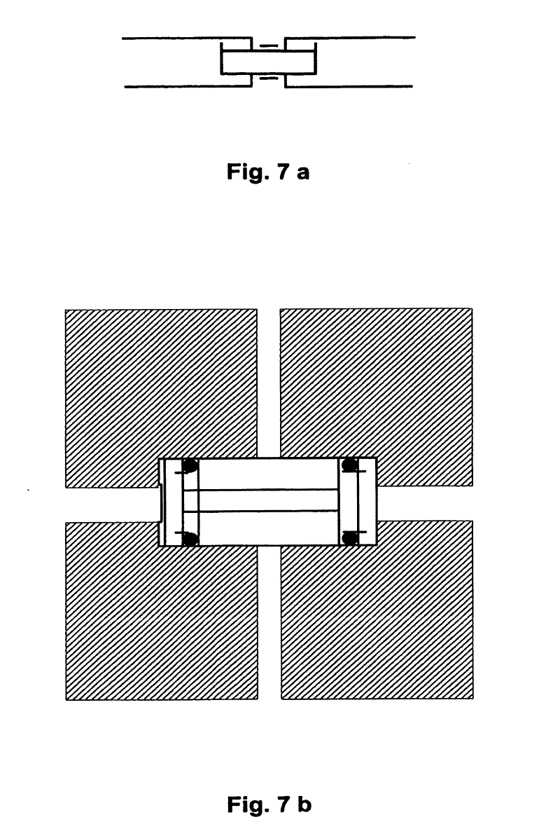

FIG. 8 a longitudinal section through a device according to the invention having internal air cooling;

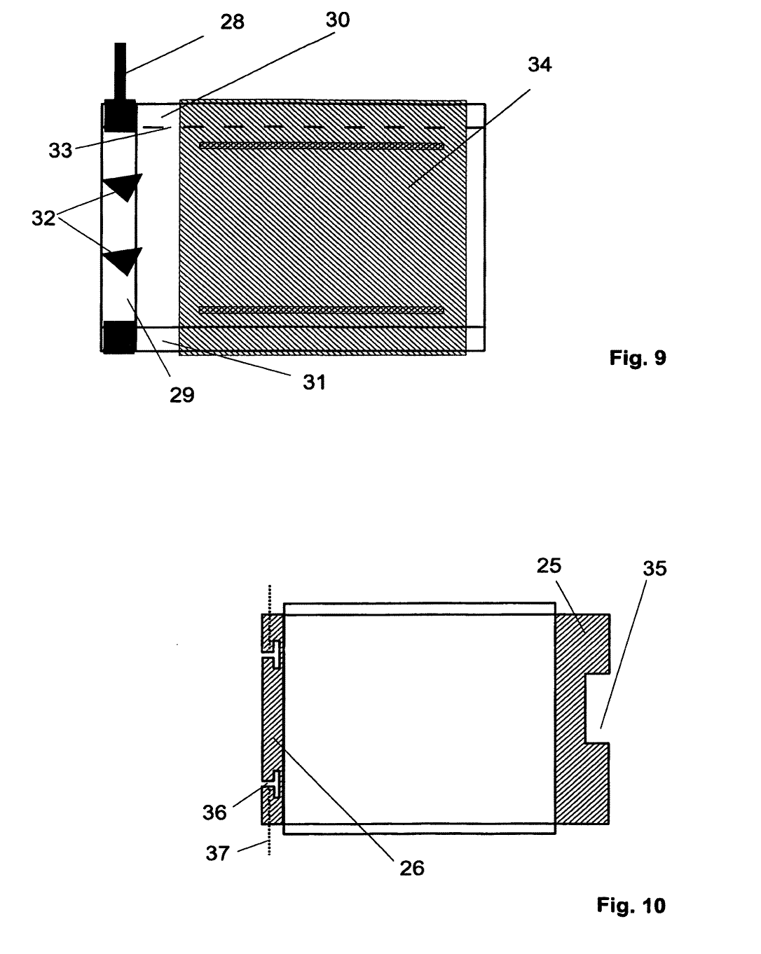

FIG. 9 a longitudinal section through a first heat conducting means of the device according to the invention, which comprises a distribution device and a capillary-active non-woven fabric;

FIG. 10 a side view of an embodiment of the device according to the invention;

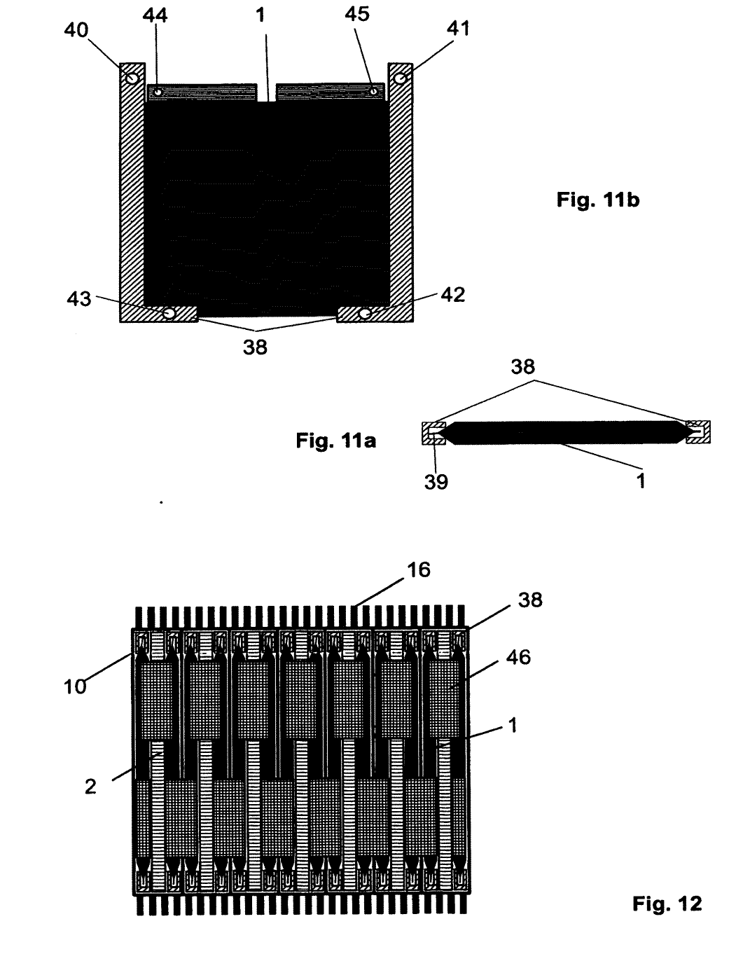

FIG. 11 a plan view of a galvanic cell accommodated in a profile frame;

FIG. 12 a plan view of a device according to the invention without a cover and without the second shaped part; and

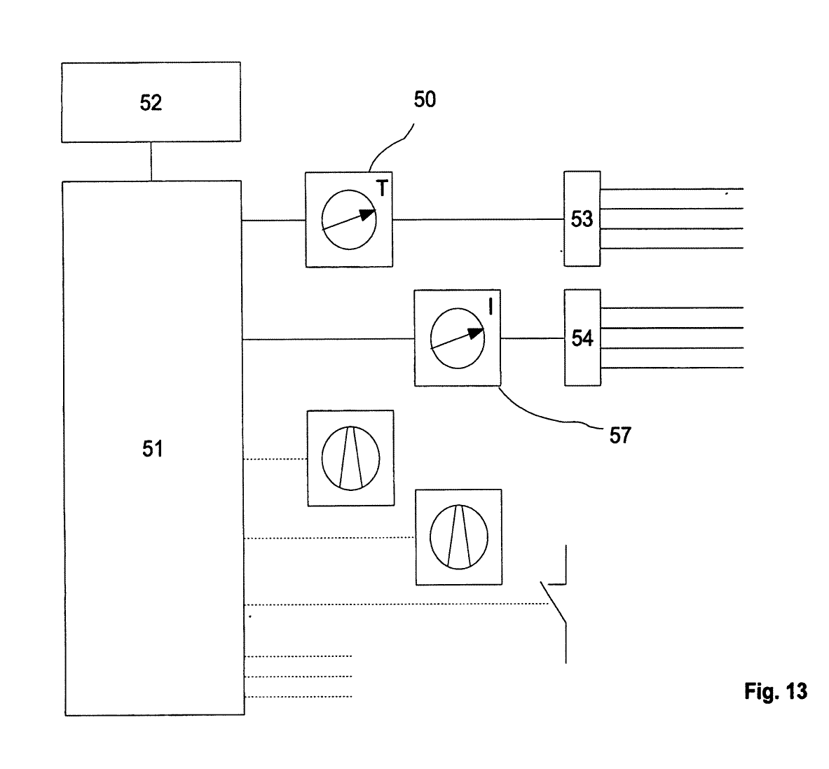

FIG. 13 an arrangement according to the invention of control and measurement devices

FIG. 1a shows a cross-section of an aluminum extruded profile element 10. The illustration is not true to scale. The extruded profile element 10 illustrated comprises eight first regions, which are configured as cell holders 4 and are each intended for holding two galvanic cells 1.

FIG. 1b shows a side view of an aluminum extruded profile element 10. The illustration is not true to scale. The extruded profile element 10 illustrated comprises eight first regions, which are configured as cell holders 4 and are each intended for holding two galvanic cells 1. The region boundaries of two cell storage devices 4 are indicated by dashed lines. The extruded profile element 10 is assigned a cover element 25 and a base element 26 on two opposite sides.

FIG. 2a shows a preferred embodiment of the device according to the invention in cross-section. The illustration is not true to scale. The cell holders 4 shown each comprise a first wall element 9, which is configured as a rectangular tube. The cell holders 4 are glued to the first shaped part 6, which spaces the cell holders 4 a uniform distance apart. In the embodiment shown, in each case one heat conducting means 3 is arranged between two cell holders 4. These heat conducting means each have only one first fluid channel 8, which passes through the device according to the invention from a first side to a second side opposite to this first side.

FIG. 2b shows a side view of a preferred embodiment of the device according to the invention. The illustration is not true to scale. The cell holders 4 shown each comprise a first wall element 9, which is configured as a rectangular tube. The cell holders 4 are glued to the first shaped part 6 and to the second shaped part 7, which space the cell holders 4 a uniform distance apart. A base element 26 is screwed to the first shaped part 6 and a cover element 25 is screwed to the second shaped part 7. In the embodiment shown, in each case one heat conducting means 3 is arranged between two cell holders 4. These heat conducting means 3 have only one first fluid channel each, which pass through the device according to the invention from a first side to a second side opposite to this first side.

FIG. 3a shows an aluminum extruded profile element 10 for an energy storage unit according to the invention with extended service life. The illustration is not true to scale. The illustrated embodiment of the aluminum extruded profile element 10 comprises eight first sections, which are configured as cell holders 4. A second section 5 of the aluminum extruded profile element is arranged between each two first sections. These second sections are fully metallic and comprise recesses 27 on two sides.

FIG. 3b shows a side view of a preferred embodiment of the device according to the invention. The illustration is not true to scale. The cell holders 4 shown each comprise a first wall element 9, which is configured as a rectangular tube. A heat conducting means 3 with a metallic core is arranged between each two cell holders 4. The heat conducting means each have five second fluid channels 14 with round cross-section, which pass through the device according to the invention from a first side to a second side opposite to this first side. The cell holders 4 are glued to the first shaped part 6 and to the second shaped part 7. A base element 26 is screwed to the first shaped part 6 and a cover element 25 is screwed to the second shaped part 7.

FIG. 4 shows a cross-section of an aluminum extruded profile element 10. The illustration is not true to scale. The extruded profile element 10 illustrated comprises eight first regions, which are configured as cell holders 4 and are each intended for holding two galvanic cells 1. In addition, the extruded profile element 10 shown comprises cooling fins 16, which are provided to increase the outer surface of this extruded profile element 10 and to increase the absorption and emission of electromagnetic radiation. The aluminum extruded profile element and the cooling fins are produced integrally, preferably from the same material.

FIG. 5 shows a longitudinal section through a device according to the invention having air cooling. The illustration is not true to scale. The energy storage unit shown comprises four groups each of two plate-shaped galvanic cells 1. Each galvanic cell comprises 2 current collectors 11. An electrically insulating terminating element 13 is associated with each current collector 11 of a galvanic cell 1. The four groups of galvanic cells 1 are connected in parallel to increase the quantity of charge. Within a group, two galvanic cells 1 are connected in series. The electrical wiring is not shown, however. Also not shown are the individual cell casings, which are implemented as gas-tight, electrically non-conducting and welded foils.

Two galvanic cells 1 are accommodated in each cell holder 4. Every cell holder 4 in the embodiment shown has only one first wall element 9, wherein the cross-section of this first wall element 9 is rectangular. The wall element 9 is thin-walled, being produced from a highly thermally conductive metal, and encloses the galvanic cells 1 preventing trapped air. The galvanic cells are also enclosed by the wall element 9 such that the transfer of high thermal flows is possible between a galvanic cell 1 and the wall element 9. The first wall elements 9 are each glued on a first side to the first shaped part 6, and on the second side opposite to this first side, to the second shaped part 7. The cover 25 is screwed to the second shaped part 7. The screw fixings are shown as dashed lines.

In the embodiment illustrated every cell holder 4 has a plate-like position adjusting means 2, wherein the position adjusting means 2 is in each case associated with two galvanic cells 1 and is in flat contact with them.

At least one heat conducting means 3 is associated with a cell holder 4 in the embodiment illustrated. This heat conducting means 3 has a first fluid channel 8, which passes through the device according to the invention from a first side to a second side opposite to this first side. This fluid channel 8 is intended preferably for external air to flow through. Depending on the temperatures of the operatively connected galvanic cell 1 and the external air, thermal energy is either supplied to these galvanic cells 1 or dissipated from them.

In the illustrated embodiment of the device according to the invention the fluid channel 8 comprises two highly liquid-wetting non-woven fabrics 14, which in some regions are glued to a first wall element 9 and which are provided for wetting these first wall elements 9 on one side, in some regions, with a second fluid.

FIG. 6 shows a longitudinal section through a device according to the invention having air cooling. The illustration is not true to scale. The energy storage unit shown comprises four groups each of two plate-shaped galvanic cells 1. Each galvanic cell has two current collectors 11. An electrically insulating terminating element 13 is associated with each current collector 11 of a galvanic cell 1. The four groups are connected in parallel, to increase the amount of charge. Within a group, two galvanic cells 1 are connected in series. The electrical wiring is not shown, however. Also not shown are the individual cell casings, which are implemented as gas-tight, electrically non-conducting and welded foils.

One group of two galvanic cells 1 is accommodated in each cell holder 4. Every cell holder 4 in the embodiment shown has only one first wall element 9, wherein the cross-section of this first wall element 9 is rectangular. The wall element 9 is thin-walled, being produced from a highly thermally conductive metal, and encloses the galvanic cells preventing trapped air. The galvanic cells are also enclosed by the wall element 9 such that the transfer of high thermal flows is possible between a galvanic cell 1 and the wall element 9. The first wall elements 9 are each glued on a first side to the first shaped part 6, and on the second side opposite to this first side, to the second shaped part 7. The cover 25 is screwed to the second shaped part 7.

In the embodiment illustrated every cell holder 4 has a plate-like position adjusting means 2, wherein the position adjusting means 2 is in each case associated with two galvanic cells 1 and is in flat contact with them.

At least one heat conducting means 3 is associated with a cell holder 4 in the embodiment illustrated. This heat conducting means 3 comprises a highly thermally conductive metallic core. The heat conducting means 3 further comprises five second fluid channels 14. The fluid channels 14 have a round cross-section and can be connected in pairs via connecting elements to a continuous fluid channel. A temperature-controlled second fluid flows though the fluid channels 14, wherein the geometry of the fluid channels 14, the material properties of the second fluid and its flow velocity are chosen such that the flow has the highest possible Reynolds number or Nusselt number. Depending on the temperatures of the effectively connected galvanic cells 1 and this second fluid, thermal energy is either supplied to or dissipated from this galvanic cell.

In the embodiment illustrated the cell holders 4 and the heat conducting means 3 are produced integrally, wherein an aluminum extruded profile element corresponding to FIG. 3 has been used.

FIG. 7a shows a connecting element 18 for fluid channels 14, through which a gaseous fluid can flow. The geometry of this connecting element 18 is matched to the geometry of the recesses in the second regions of the aluminum extruded profile element, which are not shown in this Figure. The connecting element illustrated is provided for connecting at least two fluid-channels, at least in some sections. Preferably, two fluid channels, assigned to two different devices according to the invention combined together to form a module, are connected by this connecting element. The connecting element can also in particular be configured in a U-shape. A U-shaped connecting element serves to connect two fluid channels, assigned to the same heat conducting means.

FIG. 7b shows a connecting element 19 for fluid channels 8, through which a gaseous fluid can flow. The geometry of this connecting element 19 is matched to the geometry of the recesses in the second regions of the aluminum extruded profile element, which are not shown in this Figure. The connecting element illustrated is provided for connecting at least two fluid-channels, at least in some sections. Preferably, two fluid channels assigned to two different devices according to the invention combined together to form a module, are connected by this connecting element. The connecting element can also in particular be configured in a U-shape. A U-shaped connecting element serves to connect two fluid channels, assigned to the same heat conducting device.

FIG. 8 shows a longitudinal section through a device according to the invention having internal air cooling. The attached ventilator 28 pumps a fluid, preferably external air, inside the device according to the invention. The resulting fluid flow is conveyed by the outer cell holders 4 of the device according to the invention, wherein these do not comprise any galvanic cells 1 or position adjusting means 2. In addition, the fluid flow is conveyed by a fluid channel constructed in the cover element 25, wherein the fluid flows around at least the current collectors 11 or operatively connected heat sinks. In addition, the fluid flow is conveyed by a fluid channel constructed in the base element 26. This fluid flow circulating inside the device according to the invention can also, at least in some regions, pass through a heat exchanger for providing temperature control, which is not shown. Depending on the temperature of the current collectors 11, or of the effectively connected heat sink and the fluid, thermal energy is either supplied to or dissipated from the current collectors 11 and/or the effectively connected heat sinks.

FIG. 9 shows a side view of a distribution device for a heat conducting means of the device according to the invention, through which a first fluid flows. The distribution device shown comprises a connection 28 for supplying a second fluid, a supporting frame 29 with a thickness of 1.5 mm and an upper and a lower pipe 30, 31 each with an internal diameter of 4 mm. The upper pipe 30 comprises in some regions through holes 33 with a diameter of 0.5 mm, which convey a second fluid flowing in the upper pipe 30 onto a capillary-active non-woven fabric 34. The capillary-active non-woven fabric is glued in some sections to the wall of the first fluid channel of the heat conducting means, not shown, and wets certain regions of the fluid channel wall with the second fluid. The distribution device further comprises two winglets 32, which are mounted on the support frame 29. The arrangement of the winglets 32 is chosen such that turbulence is induced in the substantially laminar flow of the first fluid, wherein the mass transfer of the second wetting fluid from liquid to gaseous form is improved.

FIG. 10 shows a side view of an embodiment of the device according to the invention. In the embodiment illustrated the cover element 25 has a cut-out 35 for the connections of the device according to the invention. In addition, the base element 26 comprises two T-grooves 36, which receive fixing elements for also fixing a plurality of devices according to the invention. The base element 26 further comprises through holes for studs 37, which fix the fixing elements fed through the T-grooves 36 in place.

FIG. 11a shows a plan view of a galvanic cell 1, which is enclosed by a cell casing 39 implemented as a gas-tight and welded foil and which is further accommodated in a two-piece profile frame 38. The two-piece profile frame 38 has a U-profile and is geometrically matched to the galvanic cell 1 which it holds, and is produced from aluminum and/or plastic. Not shown is the mounting adhesive, such as an acrylic sealing compound, used for fixing the galvanic cell 1 in the profile frame 38.

FIG. 11b shows a side view of a galvanic cell 1, which is accommodated in a profile frame 38. The two-piece profile frame 38 has a U-profile and is geometrically matched to the galvanic cell 1 which it holds, and is produced from aluminum and/or plastic. Not shown is the mounting adhesive, such as an acrylic sealing compound, used for fixing the galvanic cell 1 in the profile frame 38. The through holes 40, 41, 42, 43, 44, 45 and 46 are used for positioning the galvanic cell 1 and the two-piece profile frame 38 in a device for gluing these components together. In particular at least one bolt, geometrically matched to the size of the through hole, is used to fix the galvanic cell 1 or profile frame 38 in the device used to glue the parts together.

FIG. 12 shows a plan view of a device according to the invention without its cover and without the second shaped part. The aluminum extruded profile element 10 comprises 7 first regions which are implemented as cell holders. The aluminum extruded profile element 10 further comprises a plurality of cooling fins 16. The cell holders are each occupied by two galvanic cells 1, which are enclosed by a cell covering and accommodated in a profile frame 38. In addition, a position adjusting means, which is positioned between the two galvanic cells 1, is accommodated in each cell holder. In the illustrated embodiment of the device according to the invention, two galvanic cells each with a contact element 38, which is attached with studs, are connected in series. Altogether this results in a series circuit of 14 galvanic cells 1 in the embodiment shown.

FIG. 13 shows an arrangement according to the invention of control and measurement devices for controlling the temperature of the accumulator. A control device 51 is shown, to which a memory device 52 is assigned. Items stored in this memory device 52 are calculation rules, detected and analysed measurement variables and temperature specifications or target values. This memory device 52 further contains specifications for the temperature control of the accumulator. Using these specifications for temperature control, the control device 51 is able to switch available devices on or off in a predictive manner. The control device 51 is connected to a first measurement device 57 for detecting temperatures of connected galvanic cells. This first measurement device 50 is connected to a changeover switch 53, to which the various thermo-elements are connected. In addition, a second measurement device 57 is connected to the control device 51 for detecting electric currents. This second measurement device 57 is connected to a changeover switch 54, to which the various current meters are connected. Also connected to the control device 51 is a series of pumping devices for fluids, and control lines to various switches.

In this embodiment of the arrangement of control and measurement devices, the control device 51 is able to predictively perform the temperature control of the accumulator being operated. At the same time, the functions of the control device 51 can also be performed by another control unit present or by a higher-level battery management system.

1-13. (canceled)

14. A device for storing electrical energy, comprising:
at least one galvanic cell;
a cell holding unit, including at least one interior space, provided to at least partially accommodate the at least one galvanic cell;
a first wall element, which at least partially surrounds the interior space of the cell holding unit and is at least partially operatively connected to the at least one galvanic cell;
a heat conducting unit operatively connected to the at least one first wall element; and
a fluid channel assigned to the heat conducting unit and provided to have a first fluid flow therethrough;
at least one position adjusting unit arranged at least partially within the cell holding unit and provided to expand in a preferred direction according to at least one of temperature or ambient pressure acting thereon.

15. The device according to claim 1, wherein at least one of a nature or a size of a force exerted by the at least one position adjusting unit is determined by a geometric form or a material of the at least one position adjusting unit.

16. The device according to claim 1, wherein an increase in volume of the at least one galvanic cell during a charging cycle is compensated by a corresponding decrease in volume of at least one associated position adjusting unit.

17. The device according to claim 16, wherein at least one of a deformation or a destruction of the at least one galvanic cell or at least the cell holding unit is prevented by the at least one position adjusting unit.

18. The device according to claim 1, wherein the position adjusting unit regulates a contact pressure of the at least one galvanic cell on at least the first wall element.

19. The device according to claim 1, wherein the at least one galvanic cell comprises at least one separator which includes a material-permeable substrate,
wherein the substrate is coated on at least one side with an inorganic material,
wherein the material-permeable substrate includes an organic material, the organic material including a non-woven fabric,
wherein the organic material includes a polymer including,
wherein the organic material is coated with an inorganic ion-conducting material that is ion-conducting in a temperature range of −40° C. to 200° C.,
wherein the inorganic, ion-conducting material includes at least one compound from the group of oxides, phosphates, sulphates, titanates, silicates, aluminosilicates of at least one of the elements Zr, Al, Li, especially zirconium oxide, and
wherein the inorganic, ion-conducting material includes particles having a maximum diameter of less than 100 nm.

20. The device according to claim 1, wherein a longitudinal axes of the at least one galvanic cell and the cell holding unit and the at least one position adjusting unit and the heat conducting unit extend substantially parallel.

21. The device according to claim 1, further comprising:
at least one first shaped part provided to be connected at least to the first wall element of the cell holding unit with a force-fit, wherein the first shaped part is arranged substantially perpendicular at least to the cell holding unit.

22. The device according to claim 1, further comprising at least one cavity configured as a fluid channel.

23. The device according to claim 1, wherein a highly liquid-wetting unit is assigned at least to the fluid channel.

24. The device according to claim 1, further comprising
at least one pumping device provided to pump at least one first fluid, and wherein the at least one pumping device is controllable.

25. The device according to claim 1, wherein at least the first wall element has a higher absorption coefficient for heat radiation than at least a cell casing of the at least one galvanic cell.

26. The device according to claim 1, further comprising:
at least one first measuring unit to detect at least one measurement variable.

27. The device according to claim 26, further comprising:
at least one controlling unit provided to detect a signal from the at least one first measuring means or to control the at least one heat conducting unit.

28. The device according to claim 27, further comprising:
at least one second measuring unit to detect a current strength of a electric current into or out of the at least one galvanic cell and to transmit the current strength to the controlling unit; and
a memory device assigned to the controlling unit, and configured to store at least data or calculation rules.

29. A method for operating a device according to claim 27, wherein
the first measuring unit at least at predetermined times detects the temperature at a specified position of a galvanic cell and the second measuring unit detects the strength of the electrical current into or out of the at least one galvanic cell,
the controlling unit determines a temperature difference between the detected temperature and a temperature specified relative thereto, and
depending on at least one of the measured temperature, the determined temperature difference or the detected current strength, the controlling unit switches on or switches off at least one of the heat conducting unit or a pumping unit that pumps a fluid.

30. A method for producing a cell holding unit occupied by at least one galvanic cell and at least one position adjusting unit for a device according to claim 1 using an extruded profile element, the method comprising:
(a) dividing the extruded profile element into pieces of pre-determined length;
(b) arranging the at least one galvanic cell and the position adjusting unit;
(c) pressing this arrangement into the cell holding unit.

31. The device according to claim 18, wherein the position adjusting unit regulates the contact pressure to be at a constant value.

32. The device according to claim 19, wherein the material-permeable substrate includes a partially material-permeable substrate that is substantially permeable relative to at least one material and substantially impervious relative to at least one other material.

33. The device according to claim 26, wherein the first measuring unit measures a temperature at a specified position of the at least one galvanic cell.
